(19) United States
(12) Patent Application Publication
(10) Pub. No.: US 2010/0202624 A1
(43) Pub. Date: Aug. 12, 2010

(54) Equipment, method and use of the equipment in an audio system

(75) Inventors: Jari Mäkinen, Iisalmi (FI); Aki Mäkivirta, Lapinlahti (FI); Jussi Tikkanen, Iisalmi (FI); Juha Urhonen, Iisalmi (FI)

Correspondence Address: Muncy, Geissler, Olds & Lowe, PLLC, 4000 Legato Road, Suite 310, FAIRFAX, VA, 22033, US

(73) Assignee: GENELEC OY, Iisalmi (FI)

(21) Appl. No.: 12/294,907

(22) PCT Filed: Mar. 23, 2007
(86) PCT No.: PCT/FI2007/050159

§ 371 Date: Mar. 27, 2009

(30) Foreign Application Priority Data
Mar. 28, 2006 (FI) 20060296

(51) Int. Cl. H04R 1/08; H04R 29/00

(52) U.S. Cl. 381/59; 381/91

(57) ABSTRACT

A method and means for a sound-reproduction system. The means include a first opening arrangement for a microphone, and a second opening arrangement for a microphone stand, formed in an essentially planar elastic material.

### BACKGROUND OF THE INVENTION

1. Field of the Invention

The present invention relates to a means for a sound-reproduction system.

The invention also relates to a method in a sound-reproduction equipment.

2. Brief Discussion of the Related Art

According to the prior art, calibration methods are known, in which a test signal is fed to a loudspeaker. The response to the test signal is measured using a measuring system and the frequency response of the system is adjusted to be as even as possible using an equalizer.

A drawback of the state of the art is that, in the measuring system, the placing and firm installation of the microphone requires a microphone-specific support, which is generally very expensive and microphone specific. In addition, even in expensive microphones the microphone support attenuates acoustic and mechanical vibrations poorly, which can significantly interfere with electroacoustic measurement and calibration.

The invention is intended to eliminate the defects of the state of the art disclosed above and for this purpose create an entirely new type of means, method, and use in sound-reproduction equipment, especially in connection with its calibration.

### SUMMARY OF THE INVENTION

The invention is based on arranging for the attachment and support of the microphone an essentially planar attachment piece, which is equipped with two opening arrangements and is formed from a relatively thick flexible material, for attaching the microphone to a stand.

According to a second preferred embodiment of the invention, the attachment device is applied in an environment, in which the active loudspeaker is equipped with a signal generator, which can be used to create a logarithmically scanning sinusoidal test signal.

According to a third preferred embodiment of the invention, the attachment device is applied in an environment, in which the level of the measuring signal is adjusted in such a way as to achieve the greatest possible signal-noise ratio.

According to a fourth preferred embodiment of the invention, the attachment device is applied in an environment, in which the phase of the main loudspeaker and the subwoofer is set to be the same at the crossover frequency, with the aid of a sine generator built into the active subwoofer loudspeaker.

According to a fifth preferred embodiment of the invention, the attachment device is applied in an environment, in which a logarithmic sine signal is used to equalize the frequency responses of the loudspeakers at the listening positioning (the location of the microphone), in order to eliminate differences in the mutual levels and time-of-flight delays of the loudspeakers in the loudspeaker system.

More specifically, the means according to the invention is characterized in that it comprises a first opening arrangement for a microphone, and a second opening arrangement for a microphone stand, formed in a plate-like elastic material of even thickness.

The method according to the invention is, in turn, characterized in that the loudspeaker comprises means for forming an essentially sinusoidal electrical variable-frequency calibration signal, so that the calibration signal scans at least essentially through the entire audio-frequency range.

Considerable advantages are gained with the aid of the invention.

With the aid of the means according to the invention, it is possible to connect even a very low-priced microphone to a measuring system in a cost-effective manner. In particular, the attachment means has a very great economical significance in connection with the measuring and calibration methods described in the present application, because the highly-developed measuring and calibration method eliminates the need for measurement microphones of a very high quality and with a very high price.

According to the second preferred embodiment of the invention, because the test signal is not fed from the computer to the loudspeaker, but arises in the loudspeaker, there are no other distortions or changes in the test signal besides the acoustic response.

Besides the acoustic transfer path, the measuring signal is affected only by the measuring microphone and the frequency response of the input of the computer sound card.

Because the measuring signal is built in, it is always available.

Because the crest factor of the signal is small, it produces a good signal-noise ratio.

According to the third embodiment of the invention, the following advantages are achieved.

As the distance of the microphone can vary greatly, the magnitude of the acoustic response produced by the measuring signal can vary within very wide limits.

Noise produced by the environment does not vary in the same way, but instead remains (in each room) relatively constant.

If the microphone is very close to the loudspeaker, the signal being recorded may be too large, in which case it will be peak-limited in the computer sound card.

If the microphone is very far away, the signal may be too small relative to ambient noise, in which case the signal-noise ratio will remain poor.

An advantageous signal-noise ratio can always be ensured with the aid of level setting.

Peak limiting of the measuring signal can be prevented by reducing the level of the signal. The signal-noise ratio can be improved by raising the level of the signal.

The setting of the level is known to the controlling computer all the time, and can be taken into account in calculations.

The following advantages are achieved with the aid of the fourth embodiment of the invention:

The correct phase settings are found, irrespective of where the loudspeaker is placed (the distance affects the sound level and the placing affects the phase).

The measurement corresponds to a real situation (in which the subwoofer and main loudspeaker operate simultaneously and repeat the same audio signal).

According to the sixth preferred embodiment of the invention, all the loudspeakers of the entire loudspeaker system are brought mutually to the correct level, to a virtual distance, and with an identical room response.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only.

FIG. 1 shows a block diagram of one system suitable for the method according to the invention.

FIG. 2 shows a second calibration circuit according to the invention.

FIG. 3 shows graphically the signal according to the invention, which the computer sound card records.

FIG. 4 shows graphically a typical measured signal in the calibration arrangement according to the invention.

FIG. 5 shows graphically the test signal formed by the loudspeaker.

FIG. 6 shows the attachment means according to the invention.

FIG. 7 shows the attachment means of FIG. 6 connected to the microphone and to the microphone stand.

In the invention, the following terminology is used:

1 loudspeaker

2 loudspeaker control unit

3 acoustic signal

4 microphone

5 preamplifier

6 analog summer

7 sound card

8 computer

9 measuring signal

10 test signal

11 USB link

12 control-network controller

13 control network

14 IO line

15 signal generator

16 loudspeaker element

18 interface device

50 calibration signal

100 microphone holder

101 microphone opening

102 stand opening

103 groove for microphone lead

104 microphone lead

105 microphone stand

### DETAILED DESCRIPTION OF THE PREFERRED EMBODIMENTS

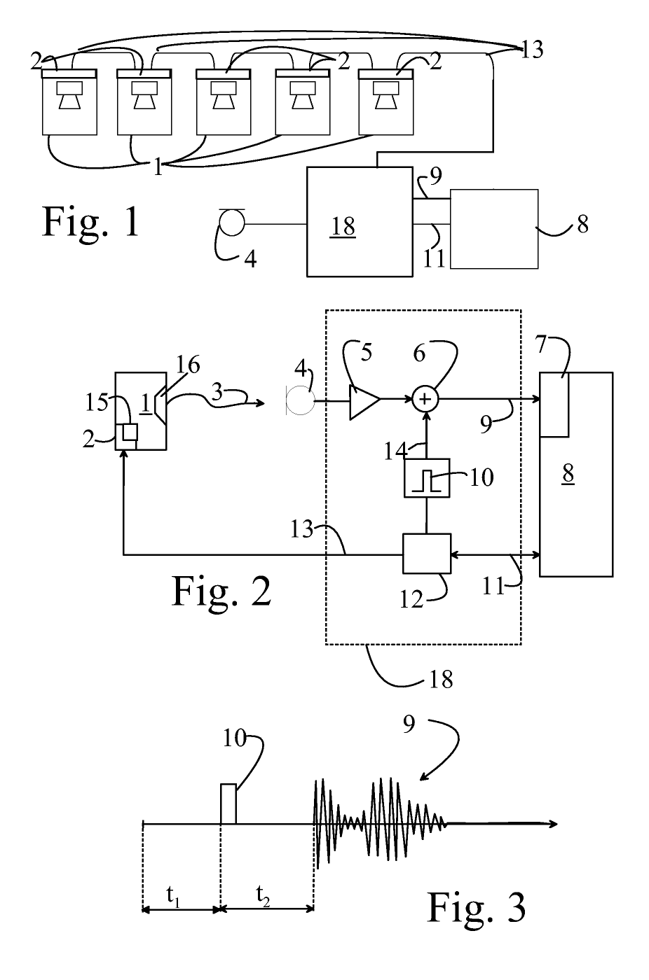

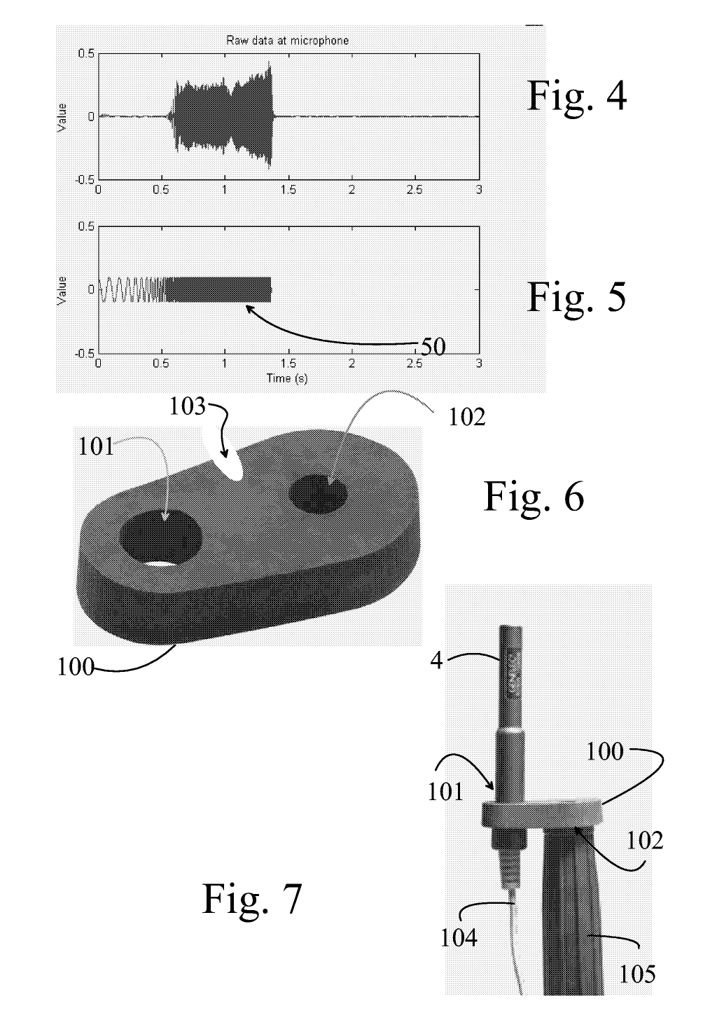

FIG. 1 shows the apparatus totality, in which loudspeakers 1 are connected to a computer 8 through a control network 13, by means of an interface device 18.

The interface device 18 contains a control-network controller 12 according to FIG. 2, a preamplifier 5 and an analog summer 6, to which an IO line 15 coming from the control-network controller, through which IO line a test signal 10 is transmitted to the summer, is connected.

FIG. 2 contains the same functions as FIG. 1, but only one loudspeaker 1 is shown, for reasons of clarity.

FIG. 2 shows the apparatus totality of the invention, in which the loudspeaker 1 produces an acoustic signal 3. For test purposes an acoustic signal 3 is created from an electrical calibration signal formed by the generator 15 of the control unit 2 of the loudspeaker itself. The control unit 2 typically contains an amplifier thus making the loudspeaker (1) an active loudspeaker. The test signal is preferably a sinusoidal scanning signal, such as is shown graphically, among others, in FIG. 6. The frequency of the calibration signal 50 (FIG. 5) is scanned over the range of human hearing, preferably in such a way that this starts from the lowest frequencies and the frequency is increased at a logarithmic speed towards the higher frequencies. The generating 50 of the calibration signal is started by a signal brought to the control unit 2 of the loudspeaker 1 over the control bus 13. The acoustic signal 3 is received by the microphone 4 and amplified by a preamplifier 5. In the analog summer 6, the signal coming from the preamplifier 5 is combined with the test signal 10, which is typically a square wave. The analog summer 6 is typically a circuit implemented using an operation amplifier. The test signal 10 is obtained from the control unit 12 of the control network. In practice, the test signal can be obtained directly from the IO line 14 of the microprocessor of the control unit of the control network.

Thus, according to the invention the acoustic measuring signal 3 can be initiated by remote control through the control bus 13. The microphone 4 receives the acoustic signal 3, with which the test signal 10 is summed The sound card 7 of the computer 8 receives a sound signal, in which there is initially the test signal and then after a specific time (the acoustic time-of-flight) the response 9 of the acoustic signal, according to FIG. 2.

FIG. 3 shows the signal produced in the computer's sound card 7 by the method described above. The time t₁ is a randomly varying time caused by the operating system of the computer. The time t₂ to the start of the acoustic response 9 is mainly determined on the basis of the acoustic delay (time of travel), and random variation does not appear in it. The acoustic response 9 is the response of the loudspeaker-room system to the logarithmic sinusoidal scanning, the frequency of which is increasing.

According to the second preferred embodiment of the invention, a generator 15, which produces a calibration signal 50 that is precisely known beforehand, is built into the loudspeaker 1.

The calibration signal produced by the generator 15 is sine-scanning, the speed of which frequency scanning increases in such a way that the logarithm of the frequency at the moment is proportional to the time, log(f)=k t, in which f is the momentary frequency of the signal, k is a constant defining speed, and t is time. The increase in frequency accelerates as time passes.

Because the test signal is precisely defined mathematically, it can be reproduced in the computer accurately, irrespective of the test signal produced by the loudspeaker 1.

Such a measuring signal contains all the frequencies and the crest factor (the relation of the peak level to the RMS level) of the signal is very advantageous in that the peak level is very close to the RMS level, and thus the signal produces a very good signal-noise ratio in the measurement.

As the signal 50 (FIG. 5) starts moving from the low frequencies and its frequency increases, the signal operates advantageously in rooms with a reverberation time that is usually longer at low frequencies than at high frequencies.

The generation of the calibration signal 50 can be initiated using a command given through remote control.

According to the fourth preferred embodiment of the invention, the magnitude of the calibration signal 50 produced in the loudspeaker can be altered through the control network 13.

The calibration signal 50 is recorded. The magnitude of the acoustic response 9 of the calibration signal 50 relative to the calibration signal is measured. If the acoustic response 9 is too small, the level of its calibration signal 50 is increased. If the acoustic response 9 is peak limited, the level of the calibration signal 50 is reduced.

The measurement is repeated, until the optimal signal-noise ratio and level of the acoustic signal 9 have been found.

Level setting can be performed for each loudspeaker separately.

Because the extent to which the level has been altered is controlled by the computer 8 and thus known, this information can be taken into account when calculating the results, so that a reliable measurement result, which is scaled correctly relative to the level, will be obtained irrespective of the distance.

According to the fourth preferred embodiment of the invention, a built-in sine generator is used in the subwoofer. The phase of the subwoofer is adjusted through the control-network 13 from the computer and the acoustic signal is measured by means of the microphone.

Setting the subwoofer and the main loudspeaker to the same phase at the crossover frequency takes place in two stages.
Stage 1: the levels of the subwoofer and the reference loudspeaker are set to be the same by measuring one or both levels separately and setting the level produced by each loudspeaker.
Stage 2: both loudspeakers repeat the same sine signal, which the subwoofer generates.

The common sound level is measured by the microphone.

The phase is adjusted and the phase setting at which the sound level is at a minimum is sought. The loudspeaker and subwoofer are then in an opposing phase.

The subwoofer is altered to a phase setting that is at 180 degrees to this, so that the loudspeaker and the subwoofer are in the same phase and thus the correct phase setting has been found.

According to the fifth preferred embodiment of the invention, the acoustic impulse response of all the loudspeakers 1 of the system is measured using the method described above. Such a calibration arrangement is shown in FIG. 3.

The frequency response is calculated from each impulse response.

The distance of the loudspeaker is calculated from each impulse response.

On the basis of the frequency response, settings of the equalizer filter that will achieve the desired frequency response in the room (even frequency response) are planned.

The (relative) sound level produced by the equalized response is calculated.

A delay is set for each loudspeaker, by means of which the measured response of all the loudspeakers contains the same amount of delay (the loudspeakers will appear to be equally distant).

A level is set for each loudspeaker, at which the loudspeakers appear to produce the same sound level at the measuring point. The level of each loudspeaker can be measured from the frequency response, either at a point frequency, or in a wider frequency range and the mean level in the wider frequency range can be calculated using the mean value, RMS value, or median. In addition, different weighting factors can be given to the sound level at different frequencies, before the calculation of the mean level. The frequency range and the weighting factors can be selected in such a way that the sound level calculated in this way from the different loudspeakers and subwoofers is subjectively as similar as possible. In a preferred implementation, the mean level is calculated from the frequency band 500 Hz-10 kHz, using the RMS value and in such a way that all the frequencies have the same weighting factor.

The subwoofer(s) phase is then adjusted as described above.

According to FIGS. 6 and 7, the microphone holder 100 is essentially planar and is formed from an elastic material such as rubber or an elastic plastic. The holder is preferably formed from a plate-like material of even thickness, for example, by laser cutting, or impact cutting with the aid of a die. Both a microphone opening 101 and an opening for the stand 105 are formed in the holder 100. The openings 101 and 102 can be given a conical shape, in order to adapt the holder to as many different kinds of stand 105 and microphone 4 as possible. In addition, the microphone holder 100 can be equipped with a groove 103 formed in its outer surface, for the microphone lead. The groove 103 is intended to reduce the mechanical loading of the microphone lead 104 on the contact point of the microphone 4.

The opening shapes shown in the figures can of course be different. Thus both triangular and other polygonal shapes are, within the scope of the inventive idea, possible manners of attachment for both the microphone and the stand. Opening arrangements equipped with incisions can also be accommodated within the scope of the inventive idea.

In the present application the term audio frequency range refers to the frequency range 10 Hz-20 kHz.

In a preferred implementation, the stages described above are performed in the following order:
the acoustic responses of all the loudspeakers are recorded with the aid of the computer sound card,
the impulse response of the loudspeaker is calculated from each of the responses,
the time of travel of the sound is measured from each impulse response and the distance of the loudspeaker is calculated on its basis,
on the basis of the distance of each loudspeaker, the additional delay that makes the time of travel of the sound coming from the loudspeaker the same as that of the time of travel of the other loudspeakers is calculated,
the frequency response is calculated from each impulse response,
on the basis of the frequency responses, the levels of the loudspeakers are calculated,
a correction is calculated for each loudspeaker, which will make its level the same as that of the other loudspeakers.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A means for a sound-reproduction system, comprising:
a first opening arrangement for a microphone, and
a second opening arrangement for a microphone stand,
formed in a plate-like elastic material of even thickness.

2. The means according to claim 1, further comprising a groove arrangement for a microphone lead.

3. The means according to claim 1, wherein at least one of the opening arrangements has a circular shape.

4. The means according to claim 1, wherein the cross-section of at least one of the opening arrangements is conical.

5. The means according to claim 1 for a sound-reproduction system, which comprises a loudspeaker, control apparatus for the loudspeaker, signal and control connections to the loudspeaker, a microphone for measuring the response of the loudspeaker, and analysis and control apparatuses for analysing and setting the signal obtained from the microphone, on the basis of the analysis results, wherein:
the loudspeaker comprises means for forming an essentially sinusoidal electrical variable-frequency calibration signal, so that the calibration signal scans at least essentially through the entire audio-frequency range.

6. A method for supporting and attaching a microphone in a sound-reproduction system, wherein the microphone is attached to a microphone stand with the aid of a unified, planar, elastic attachment means, in such a way that the microphone is attached with the aid of a first opening arrangement to the attachment means and the attachment means is, for its part, attached to the microphone stand with the aid of a second opening arrangement.

7. The method according to claim 6, wherein the microphone lead is supported in a groove arrangement.

8. The method according to claim 6, wherein at least one of the opening arrangements is formed with a circular shape.

9. The method according to claim 6, wherein at least one of the opening arrangements is formed with a conical cross-section.

10. Use of a plate-like elastic material of even thickness equipped with two holes as a microphone holder.
